(19) United States
(12) Patent Application Publication
(10) Pub. No.: US 2015/0203731 A1
(43) Pub. Date: Jul. 23, 2015

(54) Flame-Resistant Coating For The Rear Side Of A Carpet

(71) Applicant: CLARIANT INTERNATIONAL LTD, Muttenz (CH)

(72) Inventors: Timo Herrlich, Affing (DE); Christian Steib, Koeln (DE); Andreas Lang, Augsburg (DE)

(73) Assignee: Clariant Finance (BVI) Limited, Tortola (VG)

(21) Appl. No.: 14/421,675

(22) PCT Filed: Aug. 3, 2013
(86) PCT No.: PCT/EP2013/002332

§ 371 Date: Feb. 13, 2015

(30) Foreign Application Priority Data
Aug. 16, 2012 (DE) 10 2012 016 171.9
Sep. 4, 2012 (DE) 10 2012 017 469.1

(51) Int. Cl. C09J 191/06; D06N 7/00; C08K 5/5313; C08K 3/22; C08K 3/04; C08K 3/32

(52) U.S. Cl. CPC C09J 191/06; C08K 3/04; C08K 3/32; C08K 5/5313; C08K 3/22; D06N 7/0078; C08K 2003/323; C08K 2003/2227; D06N 2209/067

(57) ABSTRACT

A hot-melt adhesive designed to be flame-resistant, characterized in that the adhesive contains the following components: a) 20 to 70 percent by weight of one or more polyolefin wax(es) of one or more C3-C18 [alpha]-olefin(s) and optionally ethylene; b) 9 to 30 percent by weight of expanded graphite; c) 5 to 30 percent by weight of a further flame retardant; d) 0 to 15 percent by weight of an antistatic agent; e) 0 to 12 percent by weight of one or more resin(s); f) 0 to 40 percent by weight of one or more amorphous, atactic poly [alpha]-olefin(s) (APAO).

The invention relates to a preparation having a flame-retardant finish for gluing or fixing textile sheet-like structures (e.g. floor covering constructions, wovens, nonwovens, tufted goods, in particular carpets) and textile composites (textile laminations) and to the products finished with this preparation.

“Textile sheet-like structures” in this connection are understood as meaning sheet-like structures formed from fibers or filaments, including all types of fiber nonwovens (bonded, non-bonded, needlepunched, non-needlepunched nonwovens), fiber mats, curtain materials, thermal insulation materials, acoustic insulation materials, laid goods (carpeting), textile wallpapers, functional clothing (e.g. electrically heated motorcycle or ski clothing), textile motor vehicle and aircraft interior trim (e.g. seat covers, roof felts) and the like.

Coating of textile sheet-like structures with flameproofing compositions is a process which is often technically involved and can be carried out in the most diverse ways. Depending on the process, various carrier systems are preferred for the flame-retardant material (e.g. solution, dispersion, emulsion, solid), which in turn are applied using various techniques (e.g. spraying, knife-coating, flocking of melts). Coating of the textile sheet-like structures with flameproofing agent by the techniques mentioned usually leads to a considerable increase in the weight of the composite. A further disadvantage in the preparation and processing of such compositions is also that organic solvents are often used, which require a high outlay on apparatus for compounding and also for recovery of the solvent, and add additional toxicological and safety problems to the processing (explosion protection) and use (VOC - volatile organic compounds).

The current coating technologies used most frequently in practice employ systems based on aqueous latex dispersions, polyurethane or polyacrylates as binders for the fixing of textile sheet-like structures, in particular on carpets, but also on nonwovens, woven goods and tufted goods. The use of latex and polyurethane as a coating material furthermore leads to a higher total weight because of the higher density of these binder systems compared with polyolefins, and, due to the irreversible curing of the binders, to an end product which is only incompletely recyclable with respect to the materials and raw materials. In addition, as a result of the process, due to the high consumption of water, long drying zones and associated consumption of energy, coating with aqueous latex dispersions or polyurethanes are more space- and cost-intensive in the long term than modern coating technologies based on hot-melt adhesive compositions as binders.

The use of polymers, in particular of polyolefins (PE, PP), as binders for fixing textile sheet-like structures indeed leads to a significant reduction in weight, but because of the higher combustibility of polyolefins as binders imposes particularly high requirements on the flameproofing finish itself.

It is already known that the finishing of textiles and of polymeric binders with flameproofing agents leads to a higher flame resistance and a significant slowing down of the spread of fire in the sheet-like structures. Appropriate flameproofing agents for textiles can be looked up in Kirk-Othmer Encyclopedia of Chemical Technology, Wiley, 2000, Flame Retardants for Textiles, and for polymers in Ullmann's Encyclopedia of Industrial Chemistry vol. 5, 2000, Plastics, Additives, chap. 6. A flame-retardant finish comprises one or more flameproofing agents and possibly further components, such as carrier materials or substances having additional functions. Flameproofing agents can act on the fire both by chemical reactions and by physical effects. Flameproofing agents which act in the condensed phase can remove energy from the system by removal of heat, vaporization, dilution or by endothermic reactions. Intumescent systems protect the polymer from further pyrolysis by the formation of a voluminous, insulating protective layer by carbonization and simultaneous foaming. Furthermore, the viscosity and, closely associated with this, the temperature of the melt must promote a formation of small blisters and thus render possible the formation of a microcellular system. This important group of intumescent flameproofing agents includes e.g. mixtures of ammonium polyphosphate, melamine and dipentaerythritol (carbonized) or expandable graphite. Expandable graphites are produced by reacting graphite with fuming nitric acid or concentrated sulfuric acid with incorporation of NOₓ or, respectively, SOₓ into the interstitial planes of the graphite. Under the action of heat the expandable graphite expands and forms an intumescent layer on the surface of the material.

Nevertheless, the largest proportion by volume of flameproofing agents is formed by the inorganic metal hydroxides of aluminum or magnesium. These likewise act in the condensed phase, but are not capable of forming a protective layer. Their action lies in their endothermic decomposition, whereby water is released. This results in a dilution of the fire gases and a cooling of the polymers. Al(OH)₃ thereby decomposes at 230° C. with an energy consumption of 75 kJ/mol, while Mg(OH)₂ degrades only at 340° C. and with an energy consumption of 81 kJ/mol. However, 40-60% per cent by weight of these inorganic additives are required to effect an approximately efficient flameproofing.

DE 3813252 describes thermally expanding fireproofing compositions which comprise expandable graphite and for the preparation of which an aqueous latex dispersion has been used. However, coating of textile sheet-like structures with such a dispersion leads to longer space- and energy-intensive drying times and to a significant increase in the weight of the sheet-like structure to be coated, and to the disadvantage of a lack of “end of life” option with respect to raw material recyclability.

EP 0752458 describes a method for flame-retardant finishing of textile sheet-like structures produced substantially from combustible fibers, in which expandable graphite is applied in the form of discrete, adhesive flocks to at least one surface of the sheet-like structure (note: reverse side coating). As well as the increase in flame resistance and a marked delay in the spread of fire with a simultaneous reduction in the smoke gas density in the event of fire, the flame-retardant finish is said to lead also to an only reduced increase in the weight of the sheet-like structures. The inventors are evidently certainly aware that the applicability of mixtures does not function in their formulations and therefore separate the individual components (binder, flameproofing agent) when used in the process. The dispersing of flameproofing agents in highly viscous polymer systems furthermore is too poor to achieve a uniform flameproofing action. The method described comprises spraying the surfaces of the sheet-like structure with a liquid binder, then sprinkling the expandable graphite flocks having a flame-retardant action on the sprayed surface and finally spraying the flocked surface again with the liquid binder. It is further described that the application of the expandable graphite to the surface can take place in the form of a dispersion or suspension. A disadvantage of the method described is the involved stepwise application of the flameproofing and its components, which leads to an increased complexity of the process. The use of dispersions or suspensions is also described, which requires drying of the textile sheet-like structure and therefore reduces the production speed.

The use of polymer-based hot-melt adhesive compositions overall suffers from too high a viscosity of the polymeric components of these binders, so that additions of flameproofing agents and other additives, which as a general rule increase the viscosity further, greatly impede processability. The use of low-viscosity wax-like polyolefins as binders, however, leads to a new problem in the event of fire, namely a so-called “candlewick effect” which is typical in particular of waxes, in which the low-viscosity polyolefin wax is sucked into the textile fibers by capillary forces in the event of fire. This candlewick effect can also occur if the polyolefin wax has only a simple flameproofing finish, since in the event of fire the candlewick effect usually leads to a separation of polyolefin wax and flameproofing agent. Such waxes differ from the chemically related polymer in particular by their lower molecular weight and, correlating with this, by their lower melt viscosity. In demarcation from plastics, polyolefin waxes are understood here as meaning those polyolefins which have a melt viscosity at 170° C. below 40,000 mPa.s. Compared with a polyolefin wax, an analogous polymer melts at higher temperatures and has a significantly higher viscosity. Such binders with higher melting points and melt viscosities require higher processing temperatures or the use of solvents. In the extreme case the former already leads to premature foaming of the expandable graphite on application of the flame-retardant mixture in the melt.

The object of the invention is to eliminate these disadvantages arising with the known fireproofing compositions and to develop a system which is not based on dispersions, suspensions or solutions but manages without dissolving/dispersing/suspending agents and can be employed “ready-to-use”, that is to say ready for use without further components. A further object of the invention is to utilize the advantages by using a polyolefin wax as the main component of the hot-melt adhesive composition and to prevent the disadvantage of a candlewick effect.

It has now been found that a hot-melt adhesive composition having a flame-retardant finish and based on polyolefinic homo- and copolymer waxes with a synergistic combination of an intumescent flameproofing agent, such as expandable graphite, and/or a physically and/or chemically active flameproofing agent, such as e.g. aluminum hydroxide, is particularly suitable for meeting the requirements of being flame-resistant, since there is no candlewick effect, having a low smoke gas density during flaming, being “ready-to-use” (can be employed ready for use), and being applicable using the usual HMA coating installations.

At the same time it has been found that admixing conductive carbon black to the hot-melt adhesive composition according to the invention not only improves the antistatic finish of the textile sheet-like structure, but also has a regulating effect on the melt viscosity of the entire hot-melt adhesive composition and thus additionally decreases the candlewick effect. It has moreover been found that textile sheet-like structures having a binder based on polyolefinic homo- and copolymer waxes, in particular in the case of metallocene waxes, can be separated off more easily and more thoroughly by means of a solvent-based recycling method because of their low dissolving temperatures compared with chemically related polymers of higher molecular weight, and are particularly suitable for recovering the material components (flameproofing system and polyolefin wax) from these in a pure form. The hot-melt adhesive composition according to the invention is furthermore suitable for sheet-like structures both with closed surfaces, such as e.g. film and laminates, and for open surfaces, such as the reverse sides of carpets, woven fabric and generally textile sheet-like structures. Due to the homogeneous mixing of the preparation, a very thin closed layer can be formed on the particular carrier, which leads to a considerable saving in the weight of the material compared with conventional coatings. The hot-melt adhesive composition according to the invention thus meets the demanding fire safety standards for aircraft carpets, in particular for smoke gas density (ABD 0031/BMS 7238/39), flame resistance (FAR 25.853), surface and volume resistance (TN ESK/021/99, DIN 54345-1) and indeed with a very good dimensional stability and an application weight of between 300 and 400 g, which corresponds to a saving in weight compared with a conventional aircraft carpet coated with latex of from 300 to 500 g/m².

The invention therefore provides so-called “ready to use” (ready for use) hot-melt adhesive compositions having a flame-retardant finish, comprising
a) 20 to 70 wt. % of one or more polyolefin wax(es) of one or more C₃-C₁₈-α-olefin(s) and optionally ethylene
b) 9 to 40 wt % of expandable graphite,
c) 5 to 30 wt. % of a further flameproofing agent
d) 0 to 15 wt % of an antistatically acting auxiliary substance
e) 0 to 12 wt. % of one or more resin(s)
f) 0 to 40 wt. % of one or more amorphous, atactic poly-alpha-olefin(s) (APAO)

Preferably these hot-melt adhesive compositions comprise
a) 40 to 70 wt. % of one or more polyolefin wax(es) of one or more C₃-C₁₈-α-olefin(s) and optionally ethylene
b) 9 to 30 wt. % of expandable graphite,
c) 5 to 30 wt. % of a further flameproofing agent
d) 5 to 15 wt. % of an antistatically acting auxiliary substance
e) 0 to 12 wt. % of one or more resin(s)

Preferably, the polyolefin waxes according to the invention comprise homopolymers based on ethylene or propylene and copolymers based on polypropylene and 0.1 to 30 wt. % of ethylene and/or 0.1 to 50 wt. % of a branched or unbranched C₄-C₂₀-α-olefin. These polyolefin waxes can be prepared in a known manner by polymerization e.g. by an insertion mechanism with the aid of Ziegler or metallocene catalysts, by a free radical high pressure process or by thermal degradation of plastics-like polyolefins. Appropriate preparation processes are described, for example, in Ullmann's Encyclopedia of Industrial Chemistry, 2000, Waxes and in Ullmann's Encyclopedia of Industrial Chemistry, 2006, Metallocenes. Copolymers based on ethylene-co-vinyl acetate and amorphous polyalphaolefines (APAO) are also included according to the invention. Polyolefin waxes which have been prepared using metallocene catalysts are preferred according to the invention. It has been found, surprisingly, that polyolefin waxes based on metallocenes combine the criteria relevant to use (defined melting range, low viscosity, adhesion and cohesion, recyclability) to a better degree than, for example, waxes from the Ziegler process or from the free radical high pressure process (in this context see also 2012DE101).

Polyolefin waxes having a number-average molecular weight Mₙ of between 500 and 25,000 g/mol and a weight-average molecular weight M_{w} of between 1,000 and 40,000 g/mol and a polydispersity M_{w}/Mₙ of less than 5, preferably less than 2.5, particularly preferably less than 1.8, are preferred. The molecular weight is determined by gel permeation chromatography.

Preferably, the polyolefin waxes are distinguished by a ring/ball drip or softening point of between 40° C. and 160° C., preferably between 80° C. and 140° C., and a melt viscosity, measured at 170° C., of a maximum of 40,000 mPa.s, preferably a maximum of 20,000 mPa.s. The melt viscosities are determined in accordance with DIN 53019 using a rotary viscometer, and the ring/ball softening points are determined in accordance with ASTM D3104.

Preferably, the hot-melt adhesive composition according to the invention having a flame-retardant finish always comprises a synergistic combination of expandable graphite and one or more further flameproofing agents. The following synergistic mixing ratios have proved suitable weight ratios of expandable graphite to further flameproofing agent (combination) which have a flame-retardant action: 25% to 75% of expandable graphite and 75% to 25% of the synergist, preferably 50% to 66.6% of expandable graphite to 50% to 33.3% of the synergist, particularly preferably 50% to 60% of expandable graphite to 50% to 40% of the synergist.

Expandable graphite is prepared industrially by oxidation of graphite with sulfuric acid or nitric acid. Appropriate preparation processes and features of expandable graphite are described, for example, in Ullmann's

Encyclopedia of Industrial Chemistry, vol. 6, 2002, Industrial Carbons. Various flameproofing agents from the group of halogen-containing, (organo)phosphorus-based, nitrogen-containing and/or from the group of inorganic flameproofing agents are possible as the synergist to expandable graphite. Typical flameproofing agents and chemical flameproofing classes are described, for example, in Ullmann's Encyclopedia of Industrial Chemistry, vol. 5, 2000, Flame Retardants and in Ullmann's Encyclopedia of Industrial Chemistry, vol. 5, 2000, Plastics, Additives, chap. 6.

According to the invention, preferably, a combination of expandable graphite with a phosphorus-based flameproofing agent, such as, for example, diethylphosphine aluminate, diethylphosphine zincate and/or ammonium polyphosphate, with optionally further synergists, such as, for example, polypiperazinemorpholine derivatives, is employed as a combination having a flame-retardant action. Particularly preferably, a combination of expandable graphite with an inorganic flameproofing agent such as, for example, aluminum hydroxide or magnesium hydroxide or also zinc borate, is employed.

The combination of expandable graphite with NOR-HALS compounds is also preferred according to the invention as combinations having a flame-retardant action. NOR-HALS compounds (e.g. Hostavin NOW®, Clariant; Flamestab NOR 116®, BASF, etc.) are sterically hindered alkoxyamines, the conventional field of use of which is to be found in the field of light stabilizers.

Preferably, the hot-melt adhesive composition according to the invention having a flame-retardant finish optionally includes the use of an antistatically active auxiliary substance. The use of antistatics and other auxiliary substances for reducing static charging in textiles is adequately known and is described in Ullmann's Encyclopedia of Industrial Chemistry, vol. 5, 2011, Textile Auxiliaries, 8. Auxiliaries for Technical Textiles p. 176. Typically e.g. surfactants (e.g. quaternary ammonium compounds), salts and carbon black dispersions are used as antistatics in textiles. Metal powders and fine metal wires are also occasionally employed. Preferably, the abovementioned auxiliary substances can be used for antistatic finishing of the hot-melt adhesive composition according to the invention. Conductive carbon black can particularly preferably be employed as antistatics in the hot-melt adhesive composition according to the invention, since this surprisingly additionally counteracts the “candlewick effect” of the polyolefin wax. The hot-melt adhesive composition according to the invention comprises antistatically acting auxiliary substances in contents of between 0 to 15 wt. %.

Suitable adhesive resins are, for example, synthetic or modified terpene resins, completely or partially hydrogenated colophony resins, aliphatic hydrocarbon resins and hydrogenated and/or otherwise modified aliphatic, aliphatic-aromatic or aromatic hydrocarbon resins. The hot-melt adhesive mixture according to the invention comprises resins in contents of between 0 to 12 wt. %.

Further possible constituents of the hot-melt adhesive composition according to the invention having a flame-retardant finish are non-polar or polar polymers, such as e.g. ethylene/vinyl acetate copolymers, atactic poly-α-olefins (APAO), polyisobutylene, styrene/butadiene/styrene (SBS), styrene/ethylene/butadiene/styrene (SEBS), styrene/isoprene/butadiene/styrene (SIBS) or styrene/isoprene/styrene (SIS) block polymers, for a particularly highly stressed gluing also polyamides or polyethers. Atactic poly-α-olefins (APAO) are distinguished in this context by predominantly amorphous melt characteristics, which are manifested in a crystallinity of less than 30% determined by DSC (differential scanning calorimetry) or a melting enthalpy of less than 50 J/g. These constituents of the hot-melt adhesive composition according to the invention can be present in contents of between 0 to 40 wt. %.

The hot-melt adhesive composition according to the invention can additionally comprise fillers (e.g. calcium carbonate) or auxiliary substances such as plasticizers (e.g. hydrocarbon oils), pigments, antioxidants and further waxes. Further waxes can be both natural, optionally refined products, e.g. micro- or macrocrystalline paraffins or block paraffins, and synthetic waxes, such as e.g. Fischer-Tropsch paraffins.

Preferably, the hot-melt adhesive composition according to the invention is distinguished by a ring/ball drip or softening point of between 40 and 160° C., preferably between 80 and 160° C., and a melt viscosity, measured at 170° C., of between 5,000 and 120,000 mPa.s, preferably between 5,000 and 80,000 mPa.s, particularly preferably between 10,000 and 70,000 mPa.s. The melt viscosities are determined in accordance with DIN 53019 using a rotary viscometer and the ring/ball softening points are determined in accordance with ASTM D3104.

Preferably, the hot-melt adhesive composition according to the invention is used as a hot-melt adhesive for gluing textile sheet-like structures (e.g.

gluing textile sheets, fixing loose textile woven fabric, reverse side coating of tufted goods, carpets etc.). Preferably, the hot-melt adhesive composition according to the invention is used as a hot-melt adhesive for reverse side coating or for gluing or fixing in particular for textiles (for example carpets, roof felts, seat covers etc) in lightweight construction (for example motor vehicles or electromobility, aircraft interior trim etc.). Preferably, the hot-melt adhesive composition according to the invention is employed as a hot-melt adhesive for reverse side coating or for gluing, reverse side coating or fixing in particular of textiles, textile composites, textile sheet-like structures (wovens, tufted goods etc.) with increased fire safety regulations (e.g. flame-retardant, low smoke gas density), such as, for example, in public buildings, in particular in airports, cinemas, theatres, schools etc. Preferably, the hot-melt adhesive composition according to the invention is employed as a hot-melt adhesive for reverse side coating of electrically heated textile sheet-like structures (for example electrically heated artificial lawns, electrically heated carpets, electrically heated wallpapers etc.). Preferably, the hot-melt adhesive composition according to the invention is employed as a hot-melt adhesive for gluing electrically heated textile composites (for example electrically heated motorcycle suits, ski suits, ski boots etc.).

Preferably, the hot-melt adhesive composition according to the invention is employed as a ready for use, solvent-free compound (“ready to use”). Preferably, the hot-melt adhesive composition according to the invention is applied at between 100-180° C., particularly preferably between 120-170° C., particularly preferably between 140-160° C. (by, for example, spraying, knife-coating, pouring, casting rolling etc.).

Preferably, the application weight of the hot-melt adhesive composition according to the invention is between 25 to 2,000 g/m², particularly preferably between 100 to 1,000 g/m², particularly preferably between 300-400 g/m².

Preferably, the use of the hot-melt adhesive composition according to the invention as a fixing or reverse side coating of textile sheet-like structures or textile composites leads to these having a surface resistance and a volume resistance of less than 10⁸Ω, preferably less than 10⁷Ω, particularly preferably less than 10⁶Ω.

The typical structure of a textile sheet-like structure in the simplest case comprises a woven or nonwoven textile fiber or tufted goods (incl. carrier) and a substance or a preparation for fixing the textile fibers or filaments. A textile sheet-like composite is understood here in the broadest sense as meaning textile sheets fixed to one another. According to the invention, the hot-melt adhesive composition according to the invention assumes the task of fixing. Typical materials for the filaments and fibers of the wovens, nonwovens and tufted goods in this context can be natural fibers (for example wool, cotton, flax, sisal, coconut, cellulose fibers etc.) or synthetic fibers of LLDPE, LDPE, PP, polyester (e.g. PET, PBT) or polyamide (e.g. PA6, PA66, PA6,10) or polyacrylonitrile or mixtures thereof. In addition, the above fiber materials can additionally comprise non-combustible fibers, such as, for example, carbon, aramid and/or glass fibers. Typical materials for the carriers of tufted goods are e.g. polyethylene, polypropylene and polyester. According to the invention, the reverse side gluing or gluing consists of the hot-melt adhesive composition according to the invention. In the field of flameproofed textiles, further flame-retardant auxiliary substances likewise play an important role on the surface or within the textile fibers. Examples of typical finishing of textile fibers with a flame-retardant action are to be found, inter alia, in Kirk-Othmer Encyclopedia of Chemical Technology, Wiley, 2000, Flame Retardants for Textiles.

According to the invention, the hot-melt adhesive composition can be separated off more easily and more thoroughly because of the low dissolving temperatures of the polyolefinic homo- and copolymer waxes compared with chemically related polymers of higher molecular weight and is therefore particularly suitable for recovering the material components employed, in particular the polyolefin wax, in a pure form by a solvent-based separation method as an “end of life” option for the entire textile sheet-like composite. Suitable solvent-based separation methods (selective dissolving, selective swelling) are adequately described in 2012DE101 and in DE-A-102005026451. The use of a solvent-based separation method for recycling textile sheet-like composites and floor covering constructions, such as, for example, tufted goods, e.g. artificial lawns, carpets and woven carpets, textile wallpapers etc., for separating the materials of the textile fiber, the flameproofing additive combination (e.g. ATH together with expandable graphite) and particularly preferably the polyolefin wax is preferred. Preferably, the polyolefin wax dissolves in a pure form from the remaining textile sheet-like composite below 100° C. with a suitable solvent (e.g. toluene). The material components, in particular the polyolefin wax, are regarded as being in the pure form if the cross-contamination with another material component is not above 5 wt. %. preferably not above 2 wt. %, particularly preferably not above 0.5 wt. % and the mechanical properties (such as e.g. tensile strength, elongation at break, E modulus etc.) change by not more than 10%, preferably not more than 5%, with respect to the original value before the recycling. A prerequisite of the use according to the invention of a solvent-based separation method on the textile sheet-like composite or the floor covering constructions is that at least one of the material components, preferably the polyolefin wax employed for reverse side gluing, is soluble and the additive combination having a flame-retardant action is itself insoluble.

### EXAMPLES

The following examples are intended to explain the invention in more detail, but without limiting it to the embodiments concretely described. Unless stated otherwise, percentage data are to be understood as percentages by weight.

Various embodiments of the hot-melt adhesive composition according to the invention were tested as a reverse side coating of a carpet with the aim of achieving the fire safety standards for aircraft carpets.

The application weight of the hot-melt adhesive compositions is in each case 350 g/m².

The surface and volume resistance were determined in accordance with DIN 54345-1.

The burning properties and smoke gas density were determined in accordance with ABD 0031.

The melt viscosities of the polyolefin waxes employed and of the compounds were determined at 170° C. in accordance with DIN 53019 using a rotary viscometer.

The ring/ball softening points were determined in accordance with ASTM D3104.

The weight-average molecular weight M_{w} and the number-average molecular weight Mₙ were determined by gel permeation chromatography at a temperature of 135° C. in 1,2-dichlorobenzene against an appropriate PP or PE standard.

The ready for use hot-melt adhesive compositions were prepared by extrusion with the aid of a co-rotating 16 mm twin-screw extruder at 130° C. In the case of the compound based on polyethylene (Hostalen GA7260 G), the preparation was carried out at 160° C.

The carpet grey goods were coated by means of a hot roll at 160° C.

Corresponding flameproofed mixtures based on polyethylene (Hostalen

GA7260 G) were too highly viscous for these to be applied to the carpet. Higher processing temperatures of >170° C. led to a premature foaming of the expandable graphite.

The following commercially available products were used as components (polyolefin waxes, flameproofing agents, antistatics etc.):

TABLE 1
Raw materials employed

| | | | | Viscosity | Ring/ball | Molecular | Molecular | Poly- |
|---|---|---|---|---|---|---|---|---|
| | | | Manufac- | at 170° C. | softening | weight M_{w} | weight Mₙ | disper- |
| | Chemical identity | Trade name | turer | [mPa · s] | point [° C.] | [g/mol] | [g/mol] | sity |
| Polymer | Polyethelene | Hostalen GA7260 G | Basell | (MFR_{190° C., 2.1} 8) | (Tm: 135° C.) | — | — | — |
| Polyolefin | Copolymer wax | Licocene PP 2602 | Clariant | 6300 | 99 | 29700 | 17900 | 1.7 |
| wax | ethylene/propylene | | | | | | | |
| | Copolymer wax | Licocene PP 1502 | Clariant | 1800 | 86 | 13300 | 22100 | 1.7 |
| | ethylene/propylene | | | | | | | |
| | Copolymer wax | Licocene PP 1302 | Clariant | 200 | 90 | 11600 | 7100 | 1.6 |
| | ethylene/propylene | | | | | | | |
| Expandable | Expandable | ES 100 C10 | Kropfmühl | n.a. | n.a. | n.a. | n.a. | n.a. |
| graphite | graphite | | | | | | | |
| Flameproofing | Aluminum(III) | Apyral ATH 1E | Nabaltec | n.a. | n.a. | n.a. | n.a. | n.a. |
| agent | hydroxide | | | | | | | |
| | Ethylenediamine | Ethylenediamine | VWR | n.a. | n.a. | n.a. | n.a. | n.a. |
| | phosphate | phosphate | | | | | | |
| | Melamine | Melapur MP 200/70 | BASF | n.a. | n.a. | n.a. | n.a. | n.a. |
| | Ammonium | Exolit AP 422 | Clariant | n.a. | n.a. | n.a. | n.a. | n.a. |
| | polyphosphate | | | | | | | |
| | Ammonium | Exolit AP 750 | Clariant | n.a. | n.a. | n.a. | n.a. | n.a. |
| | polyphosphate + | | | | | | | |
| | synergist | | | | | | | |
| | Diethylphosphinic | Exolit AP 766 | Clariant | n.a. | n.a. | n.a. | n.a. | n.a. |
| | acid aluminate + | | | | | | | |
| | synergist | | | | | | | |
| | (2,2,6,6-Tetramethyl-4- | Hostavin NOW | Clariant | n.a. | n.a. | n.a. | n.a. | n.a. |
| | piperidinyl)-graft- | | | | | | | |
| | PE wax | | | | | | | |
| Antistatics | Fine disperser | Leitruβ | Kropfmühl | n.a. | n.a. | n.a. | n.a. | n.a. |
| | carbon black | SC-20 | | | | | | |
| | Glycerol | Hostastat FE 2 | Clariant | n.a. | n.a. | n.a. | n.a. | n.a. |
| | monostearates | | | | | | | |
| | N,N-Bis-(2- | Hostastat FA 68 | Clariant | n.a. | n.a. | n.a. | n.a. | n.a. |
| | hydroxyethyl)- | | | | | | | |
| | alkyl-(C16-C18)- | | | | | | | |
| | amines | | | | | | | |
| Resin | Aliphatic | Sukorez SU90 | Kolom | | | | | |
| | hydrocarbon resin | | | | | | | |
| APAO | Copolymer | Vestoplast 703 | Evonik | 4000 | | | | |
| | ethylene/(C4-C8) | | | | | | | |
| | α-olefin | | | | | | | |

n.a.—not applicable

### Example 1

### Reverse Side Coating having a Flame-Retardant Finish Based on Raw Wool (Untreated)

TABLE 2
Reverse side coating having a flame-retardant finish for carpets based on raw wool (untreated)

| Formulation for | 1 | 2 | 3 | 4 | 5 | 6 | 7 | 8 | 9 |
|---|---|---|---|---|---|---|---|---|---|
| hot-melt adhesive | (comp.) | (comp.) | (comp.) | (comp.) | (comp.) | (comp.) | (comp.) | (comp.) | (comp.) |
| Licocene 2602 | 52 | 53 | 53.5 | 52 | 52 | 52 | 52 | 52 | 52 |
| Leitruss SC-20 | 8 | 7 | 6.5 | 8 | 8 | 8 | 8 | 8 | 8 |
| Ethylenediamine | — | — | — | — | — | — | — | 40 | — |
| phosphate | | | | | | | | | |
| Melapur MP | — | — | — | — | — | 20 | 40 | — | — |
| 200/70 | | | | | | | | | |
| Exolit AP 422 | — | — | — | — | 40 | 20 | — | — | — |
| Exolit AP 750 | — | — | — | 40 | — | — | — | — | — |
| Exolit AP 766 | 40 | 40 | 40 | — | — | — | — | — | — |
| Apyral ATH 1e | — | — | — | — | — | — | — | — | — |
| Expandable | — | — | — | — | — | — | — | — | 40 |
| graphite ES | | | | | | | | | |
| 100 C 10 | | | | | | | | | |
| Surface | <10⁶ | 3.8* | 1.8* | >1* | >1* | >1* | >1* | >1* | <10⁶ |
| resistance | | 10¹¹ | 10⁸ | 10⁶ | 10⁶ | 10⁶ | 10⁶ | 10⁶ | |
| | | 500 V | 500 V | 10 V | 10 V | 10 V | 10 V | 10 V | |
| Volume | <10⁶ | 0.6* | 1.4* | 5* | 5* | 5* | 5* | 5* | <10⁶ |
| resistance | | 10⁶ | 10⁶ | 10⁹ | 10⁹ | 10⁹ | 10⁹ | 10⁹ | |
| | | 10 V | 10 V | 10 V | 10 V | 10 V | 10 V | 10 V | |
| Viscosity at | 85220 | 71640 | 63870 | 103400 | 77430 | 94700 | 129000 | 97700 | 69890 |
| 170° C. [mPa*s] | | | | | | | | | |
| Burning | burns | burns | burns | burns | burns | burns | burns | burns | burns |
| properties | | | | | | | | | sooty |
| Smoke gas | not | not | not | not | not | not | not | not | not |
| density (FAR | met | met | met | met | met | met | met | met | met |
| 25853 standard) | | | | | | | | | |

| Formulation for | 10 | 11 | 12 | 13 | 14 | 15 | 16 | 17 |
|---|---|---|---|---|---|---|---|---|
| hot-melt adhesive | (comp.) | (inv.) | (inv.) | (inv.) | (inv.) | (inv.) | (inv.) | (inv.) |
| Licocene 2602 | 52 | 52 | 52 | 52 | 52 | 52 | 52 | 52 |
| Leitruss SC-20 | 8 | 8 | 8 | 8 | 8 | 8 | 8 | 8 |
| Ethylenediamine | — | — | — | — | — | — | — | — |
| phosphate | | | | | | | | |
| Melapur MP | — | — | — | — | — | — | — | — |
| 200/70 | | | | | | | | |
| Exolit AP 422 | — | — | — | — | 20 | — | — | — |
| Exolit AP 750 | — | — | — | — | — | — | — | — |
| Exolit AP 766 | — | 30 | 25 | 20 | — | — | — | — |
| Apyral ATH 1e | 40 | — | — | — | — | 25 | 20 | 15 |
| Expandable | — | 10 | 15 | 20 | 20 | 15 | 20 | 25 |
| graphite ES | | | | | | | | |
| 100 C 10 | | | | | | | | |
| Surface resistance | <10⁶ | <10⁶ | <10⁶ | <10⁶ | <10⁶ | <10⁶ | <10⁶ | <10⁶ |
| Volume resistance | <10⁶ | <10⁶ | <10⁶ | <10⁶ | <10⁶ | <10⁶ | <10⁶ | <10⁶ |
| Viscosity at | 55310 | 79330 | 72230 | 67250 | 80360 | 45310 | 52170 | 61540 |
| 170° C. [mPa*s] | | | | | | | | |
| Burning | burns | does | does | does | does | does | does | does |
| properties | | not | not | not | not | not | not | not |
| | | burn | burn | burn | burn | burn | burn | burn |
| Smoke gas | not | met | met | met | met | met | met | met |
| density (FAR | met | | | | | | | |
| 25853 standard) | | | | | | | | |

The results in Table 2 show that the combustibility of the carpet cannot be prevented by the use of simple flameproofing systems (Comparative Examples 1-10). It is furthermore found that by varying the conductive carbon black concentration, not only the surface resistance but also the viscosity can be controlled (Comparative Example 1-3). Only the synergistic combination of expandable graphite with a further flameproofing agent, such as ATH (Comparative Examples 15-17), aluminum polyphosphate (Exolit AP 422, Comparative Example 14) or diethylphosphinic acid aluminate in combination with polypiperazinemorpholine (Exolit AP766, Comparative Examples 11-13) shows the desired flameproofing.

### Example 3

### Reverse Side Coating having a Flame-Retardant Finish Based on Blended Wool

TABLE 3
Reverse side coating having a flame-retardant finish for carpets based on blended wool (20% polyamide + 80% shorn wool)

| Formulation for | 18 | 19 | 20 | 21 | 22 | 23 | 24 | 25 | 26 |
|---|---|---|---|---|---|---|---|---|---|
| hot-melt adhesive | (comp.) | (comp.) | (inv.) | (inv.) | (comp.) | (inv.) | (inv.) | (inv.) | (inv.) |
| Licocene PP 2602 | 52 | 52 | 52 | 52 | 52 | 52 | 52 | 30 | — |
| Licocene PP 1502 | — | — | — | — | — | — | — | — | 52 |
| Licocene PP 1302 | — | — | — | — | — | — | — | 22 | — |
| Leitruss SC-20 | 8 | 8 | 8 | 8 | 8 | 8 | 8 | 8 | 8 |
| Exolit AP 422 | — | — | — | 20 | — | — | — | — | — |
| Exolit AP 766 | 30 | 25 | 20 | — | — | — | — | — | — |
| Apyral ATH 1e | — | — | — | — | 25 | 20 | 15 | 15 | 15 |
| Expandable | 10 | 15 | 20 | 20 | 15 | 20 | 25 | 25 | 25 |
| graphite ES | | | | | | | | | |
| 100 C 10 | | | | | | | | | |
| Surface resistance | <10⁶ | <10⁶ | <10⁶ | <10⁶ | <10⁶ | <10⁶ | <10⁶ | <10⁶ | <10⁶ |
| Volume resistance | <10⁶ | <10⁶ | <10⁶ | <10⁶ | <10⁶ | <10⁶ | <10⁶ | <10⁶ | <10⁶ |
| Viscosity at | 79330 | 72230 | 67250 | 80360 | 45310 | 52170 | 61540 | 26130 | 28740 |
| 170° C. [mPa*s] | | | | | | | | | |
| Burning | burns | 25 s, | 2 s, | does | 4 s, | does | does | does | does |
| properties | | 29 s | 3 s | not | 5 s | not | not | not | not |
| | | | | burn | | burn | burn | burn | burn |
| Smoke gas | not | notmet | met | met | met | met | met | met | met |
| density (FAR | met | | | | | | | | |
| 25853 standard) | | | | | | | | | |

The flameproofing of carpets of which the fibers are made of blended wool with contents of synthetic fibers (20% polyamide+80% shorn wool) is more difficult to achieve. The need for precise coordination of the flameproofing agent combination to the type of fiber employed in order to achieve an effective flameproofing manifests itself here. Thus, in Table 3 mixtures in particular with a higher expandable graphite content (20 and 25 wt. %, Examples 20, 21, 23-26) show the desired flameproofing. It could furthermore be shown that by using low-viscosity polyolefin waxes, a direct influence can be made on the melt viscosity of the entire hot-melt mixture (Examples 25+26).

### Example 4

### Flame-Retardant Hot-Melt Adhesive Extent without an Antistatic Finish

Table 4 shows the burning properties of carpets which already bring along an antistatic finish in the textile in the form of fine metal wires. In the reverse side coating having a flame-retardant finish additional antistatics (conductive carbon black) can be dispensed with in this case. The viscosity of the hot-melt adhesive compound thereby reduced leads as a result to an even better processability or the possibility of lowering the processing temperature from approx. 10° C. to approx. 40° C.

TABLE 4
Reverse side coating having a flame-retardant finish for carpets based on blended wool (20% polyamide +
80% shorn wool, <0.2 wt. % of antistatic finish in the textile, conductive filaments)

| Formulation for | 27 | 28 | 29 | 30 | 31 | 32 | 33 |
|---|---|---|---|---|---|---|---|
| hot-melt adhesive | (comp.) | (comp.) | (inv.) | (inv.) | (comp.) | (inv.) | (inv.) |
| Licocene 2602 | 60 | 60 | 60 | 60 | 60 | 60 | 60 |
| Leitruss SC-20 | — | — | — | — | — | — | — |
| Exolit AP 422 | — | — | — | 20 | — | — | — |
| Exolit AP 766 | 30 | 25 | 20 | — | — | — | — |
| Apyral ATH 1e | — | — | — | — | 25 | 20 | 15 |
| Expandable | 10 | 15 | 20 | 20 | 15 | 20 | 25 |
| graphite ES | | | | | | | |
| 100 C 10 | | | | | | | |
| Surface resistance | <10⁶ | <10⁶ | <10⁶ | <10⁶ | <10⁶ | <10⁶ | <10⁶ |
| Volume resistance | <10⁶ | <10⁶ | <10⁶ | <10⁶ | <10⁶ | <10⁶ | <10⁶ |
| Viscosity | 19830 | 17420 | 16650 | 15560 | 14450 | 14390 | 14660 |
| Burning | burns | burns | does not | does not | 6 s, | does not | does not |
| properties | | | burn | burn | 4 s | burn | burn |
| Smoke gas | not met | not met | met | met | met | met | met |
| density (FAR | | | | | | | |
| 25853 standard) | | | | | | | |

### Example 5

### Recycling of the Polyolefin Wax by Selective Dissolving.

10 kg of a suitable solvent (here: xylene) were added to 2 kg of carpet waste (exp. no. 23) and the mixture was heated to 80° C. The dissolving temperature of the Licocene 2602 is 73° C. The flameproofing finish could be separated off by filtration. The textile fibers were not attacked by the solvent and were retained complete. The dissolving time was less than 20 min. The polyolefin wax was precipitated by lowering the temperature, pressed out and dried in vacua at 40° C. The solvent thereby recovered was fed to the process again.

TABLE 5
Solvent-based recycling of the carpet (exp. no. 23)

| | Licocene PP2602 | PP/PE |
|---|---|---|
| | (reverse side | copolymer wax |
| | coating) | recycled material |
| Drip point [°] | 97 | 97 |
| Tₘ [°] | 88 | 89 |
| ΔHₘ [mJ/mg] | −39 | −37 |
| Mₙ [g/mol] | 17900 | 18100 |
| M_{w} [g/mol] | 29700 | 30000 |
| PDI | 1.7 | 1.7 |
| Tensile strength [MPa] | 9.9 | 9.7 |
| Elongation at break [%] | 950 | 990 |
| Viscosity at 170° C. [mPa · s] | 5000 | 4900 |

1. A hot-melt adhesive composition having a flame-retardant finish, comprising:
a) 20 to 70 wt. % of one or more polyolefin waxes of one or more C₃-C₁₈-α-olefin(s) and optionally ethylene,
b) 9 to 30 wt. % of expandable graphite,
c) 5 to 30 wt. % of a further flameproofing agent,
d) 0 to 15 wt. % of an antistatically active auxiliary substance,
e) 0 to 12 wt. % of one or more resin(s) resins, and
f) 0 to 40 wt. % of one or more amorphous, atactic poly-α-olefin(s) (APAO)

2. A hot-melt adhesive composition having a flame-retardant finish, comprising:
a) 40 to 70 wt. % of one or more polyolefin waxes of one or more C₃-C₁₈-α-olefin(s) and optionally ethylene,
b) 9 to 30 wt. % of expandable graphite,
c) 5 to 30 wt. % of a further flameproofing agent,
d) 0 to 15 wt % of an antistatically active auxiliary substance, and
e) 0 to 12 wt. % of one or more resin(s) resins

3. The hot-melt adhesive composition having a flame-retardant finish as claimed in claim 1, wherein the polyolefin waxes are one or more homopolymers based on ethylene or propylene or one or more copolymers comprising propylene and 0.1 to 30 wt. % of ethylene, 0.1 to 50 wt. % of at least one branched or unbranched C₄-C₂₀ α-olefin or a combination thereof.

4. The hot-melt adhesive composition having a flame-retardant finish as claimed in claim 1, wherein the polyolefin waxes have a ring/ball softening point of between 40° C. and 160° C., and a melt viscosity, measured at 170° C., of a maximum of 40,000 mPa·s.

5. The hot-melt adhesive composition having a flame-retardant finish as claimed in claim 1, wherein the polyolefin wax has a weight-average molecular weight M_{w} of between 1,000 and 40,000 g/mol and a number-average molecular weight Mₙ of between 500 and 25,000 g/mol, and an M_{w}/Mₙ of <5.

6. The hot-melt adhesive composition having a flame-retardant finish as claimed in claim 1, wherein the polyolefin wax has been prepared with the aid of metallocene catalysts.

7. The hot-melt adhesive composition having a flame-retardant finish as claimed in claims 1, comprising a synergistic combination of expandable graphite and one or more further flameproofing agent in the combination of expandable graphite to flameproofing agent (combination) of from 1:3 to 3:1.

8. The hot-melt adhesive composition having a flame-retardant finish as claimed in claim 1, comprising as a further flameproofing agent one or more from the group of halogenated, N based or a combination thereof.

9. The hot-melt adhesive composition having a flame-retardant finish as claimed in claim 1, comprising a sterically hindered alkoxyamine as a flameproofing agent.

10. The hot-melt adhesive composition having a flame-retardant finish as claimed in claim 1, comprising an antistatically acting auxiliary substance from the group of conductive antistatics.

11. The hot-melt adhesive composition having a flame-retardant finish as claimed in claim 1 comprising colophony resins and derivatives thereof or hydrocarbon resins.

12. The hot-melt adhesive composition having a flame-retardant finish as claimed in claim 1, comprising up to 40 wt. % of one or more amorphous, atactic poly-alpha-olefins having predominantly amorphous melting properties and a crystallinity of less than 30%, determined by differential scanning calorimetry.

13. The hot-melt adhesive composition having a flame-retardant finish as claimed in claims 1, wherein the hot-melt adhesive composition has a ring/ball softening point of between 40 and 160° C., and a melt viscosity, measured at 170° C., of between 5,000 and 120,000 mPa·s.

14. A hot-melt adhesive comprising a hot-melt adhesive composition as claimed in claim 1.

15. A hot-melt adhesive composition as claimed in claim 1, wherein this is applied without using a solvent as a finished mixture in the melt at between 100 to 180° C.

16. A hot-melt adhesive for the reverse side coating of textile sheet-like structures comprising a hot-melt adhesive composition as claimed in claim 1.

17. A hot-melt adhesive for the reverse side coating of electrically heated textile sheet-like structures comprising a hot-melt adhesive composition as claimed in claim 1.

18. A hot-melt adhesive for gluing electrically heated textile composites comprising a hot-melt composition as claimed in claim 1.

19. A hot-melt adhesive composition claim 1, wherein after finishing of textile sheet-like structures, the textile sheet-like structures have a surface resistance and a volume resistance of less than 10¹⁰Ω.

20. A hot-melt adhesive as claimed in claim 16, wherein the application weight of the hot-melt adhesive is between 25 to 2,000 g/m².

21. A hot-melt adhesive as claimed in claim 16 for finishing textile sheet-like structures, wherein the fibers of the sheet-like structure are made of wool, cotton, flax, sisal, coconut fibers, cellulose fibers or of combustible synthetic fibers polyester or of polyamide or polyacrylonitrile or mixtures thereof and optionally comprise a flame-retardant finish.

22. The use of a hot-melt adhesive as claimed in claim 21, wherein the fibers additionally comprise a content of non-combustible fibers, glass fibers or a combination thereof.

23. A hot-melt adhesive composition as claimed in comprises further fillers.

24. A hot-melt adhesive composition as claimed in claim 1, wherein the polyolefin wax is separated off in a pure form from the other constituents of the hot-melt adhesive composition having a flame-retardant finish and from the components of the textile sheet-like structure finished therewith by a suitable solvent-based separation method at temperatures below 100° C. with, toluene or xylene.

25. The hot-melt adhesive composition having a flame-retardant finish as claimed in claim 24, wherein the recycled polyolefin wax in the pure form deviates from its original mechanical material properties by not more than 15%.

26. The hot-melt adhesive composition having a flame-retardant finish as claimed in claim 1, wherein the polyolefin waxes have a ring/ball softening between 80° C. and 140° C.

27. The hot-melt adhesive composition having a flame-retardant finish as claimed in claim 1, wherein the polyolefin waxes have a melt viscosity, measured at 170° C., of a maximum of 20,000 mPa·s.

28. The hot-melt adhesive composition having a flame-retardant finish as claimed in claim 1, wherein the polyolefin wax has a weight-average molecular weight 1%, of between 1,000 and 40,000 g/mol and a number-average molecular weight Mₙ of between 500 and 25,000 g/mol, and an M_{w}/Mₙ of <2.5.

29. The hot-melt adhesive composition having a flame-retardant finish as claimed in claim 1, wherein the polyolefin wax has a weight-average molecular weight M_{w} of between 1,000 and 40,000 g/mol and a number-average molecular weight Mₙ of between 500 and 25,000 g/mol, and an M_{w}/Mₙ of <1.8.

30. The hot-melt adhesive composition having a flame-retardant finish as claimed in claim 1, comprising a synergistic combination of expandable graphite and one or more further flameproofing agent in the combination of expandable graphite to flameproofing agent combination of from 1:1 to 2:1.

31. The hot-melt adhesive composition having a flame-retardant finish as claimed in claim 1, further comprising a synergistic combination of expandable graphite and one or more further flameproofing agent in the combination of expandable graphite to flameproofing agent of 1:1 to 3:2.

32. The hot-melt adhesive composition having a flame-retardant finish as claimed in claim 1, comprising as a further flameproofing agent one or more from the group of organophosphorus-based flameproofing agents.

33. The hot-melt adhesive composition having a flame-retardant finish as claimed in claim 1, comprising as a further flameproofing agent one or more from the group of inorganic flameproofing agents.

34. The hot-melt adhesive composition having a flame-retardant finish as claimed in claim 1, comprising an antistatically acting auxiliary substance selected from the group consisting of: conductive carbon black, metal powder, metal wires, metal threads and non-conductive antistatics, and quaternary ammonium compounds.

35. The hot-melt adhesive composition having a flame-retardant finish as claimed in claim 1, wherein the hot-melt adhesive composition has a ring/ball softening point of between 80 and 160° C.

36. The hot-melt adhesive composition having a flame-retardant finish as claimed in claim 1, wherein the hot-melt adhesive composition has a melt viscosity, measured at 170° C., of between 5,000 and 80,000 mPa·s.

37. The hot-melt adhesive composition having a flame-retardant finish as claimed in claim 1, wherein the hot-melt adhesive composition has a melt viscosity, measured at 170° C., between 10,000 and 70,000 mPa·s.

38. A hot-melt adhesive composition according to the invention as claimed in claim 1, wherein this is applied without using a solvent as a finished mixture in the melt at between 120 to 170° C.

39. A hot-melt adhesive composition according to the invention as claimed in claim 1, wherein this is applied without using a solvent as a finished mixture in the melt at between 140-160° C.

40. A hot-melt adhesive composition as claimed in as claimed in claim 1, wherein after finishing of textile sheet-like structures, the textile sheet-like structures have a surface resistance and a volume resistance of less than 10⁸Ω.

41. A hot-melt adhesive composition as claimed in as claimed in claim 1, wherein after finishing of textile sheet-like structures, the textile sheet-like structures have a surface resistance and a volume resistance of less than 10⁶Ω.

42. A hot-melt adhesive as claimed in claim 16, wherein the application weight of the hot-melt adhesive is between 100-1,000 g/m².

43. A hot-melt adhesive as claimed in claim 16, wherein the application weight of the hot-melt adhesive is between 300-400 g/m².

44. The hot-melt adhesive composition having a flame-retardant finish as claimed in claim 24, wherein the recycled polyolefin wax in the pure form deviates from its original mechanical material properties by not more than 5%.
